(19) United States
(12) Patent Application Publication
(10) Pub. No.: US 2025/0283497 A1
(43) Pub. Date: Sep. 11, 2025

(54) Rotational Lock Mounting Systems and Methods of Use Thereof

(71) Applicant: K2 Systems, LLC, Vista, CA (US)

(72) Inventors: Saul Becerril Ortega, Guadalajara (MX); Diana Diaz Rizo, Zapopan (MX); Brett Nielsen, Oceanside, CA (US)

(21) Appl. No.: 19/056,481

(22) Filed: Feb. 18, 2025

Related U.S. Application Data
(60) Provisional application No. 63/554,316, filed on Feb. 16, 2024.

(51) Int. Cl. F16B 21/04; H02S 20/20

(52) U.S. Cl. CPC F16B 21/04; H02S 20/20

(57) ABSTRACT

A rotational lock mounting system for use with photovoltaic (PV) modules (e.g., panels) and arrays. The mounting system includes an anchor base and a standoff. The standoff further includes a standoff mounting portion and a locking component coupled thereto. The mounting system can be used by inserting the locking component of the standoff into the anchor base and rotating the standoff to secure the locking component within the anchor base.

### TECHNICAL FIELD OF INVENTION

This invention generally relates to rotational lock mounting systems for photovoltaic (PV) modules (e.g., panels) and arrays and methods of use thereof.

### BACKGROUND OF THE INVENTION

A photovoltaic (PV) installation typically includes a collection of photovoltaic modules combined and secured to a support structure that combines each of the photovoltaic components to form a photovoltaic array. Typically, photovoltaic arrays are placed in an outdoor location, commonly rooftops, so that the photovoltaic arrays are exposed to sunlight in order to produce electricity. The manner in which the PV arrays are attached to surfaces varies.

### SUMMARY OF THE INVENTION

In an aspect, the present disclosure relates to a rotational lock mounting system. Such systems can be used for mounting photovoltaic modules onto a surface. The rotational lock mounting system includes an anchor base and a standoff.

In an aspect, the present disclosure relates to an anchor base component. Anchor bases include at least two side walls that extend perpendicularly from a horizontal mounting portion. The side walls include at least a pair of flanges. A first pair of flanges can be positioned at the portion of the side walls furthest away from the horizontal mounting portion (i.e. the side wall upper portion). A second pair of flanges can be positioned closer to the horizontal mounting portion (i.e. the side wall bottom portion) than the first pair of flanges. This forms a channel capable of receiving a portion of the standoff. Pairs of flanges extend from the side walls towards the channel formed within, forming a groove capable of receiving a component of the standoff within the channel. Additionally, the first pair of flanges can be substantially longer than the second pair of flanges.

In an aspect, the present disclosure relates to a standoff component. The standoff includes a standoff mounting portion that couples photovoltaic (PV) components. The standoff mounting portion may be substantially rod-like in shape, though other shapes are possible.

The standoff further includes a locking component coupled to the standoff mounting portion and capable of coupling to the anchor base. The locking component includes a first narrow portion, a middle portion, and a second narrow portion. The two narrow portions are at opposing ends of the locking component. The middle portion is also wider than the two narrow portions. The middle portion includes at least two arms extending from the middle portion in parallel directions. Such arms each include at least one nub on their ends. The nubs extend away from the center of the locking component. A flange can be located at the border of the mounting portion and the locking component.

The locking component can further include a stabilizing portion located on the end of the locking component opposing the standoff mounting portion. The stabilizing portion can include a deformable pad. This pad is configured to be placed adjacent to a flat surface of the horizontal mounting portion of the anchor base, providing the rotational lock mounting system additional stability. The pad also assists in ensuring that a standoff is rotated to the correct position when locking the standoff in an anchor base. The horizontal mounting portion can include a raised portion or a flat portion that the deformable pad can abut.

In an aspect, the present disclosure relates to methods of using rotational lock mounting systems. Such methods include using such mounting systems to mount a photovoltaic module.

In an exemplary method, a standoff can be inserted into an anchor base such that the bottom surface of the locking component abuts an internal surface of the anchor base. As such, the deformable pad may abut the horizontal mounting portion. After insertion, the arms of the locking component run parallel to the anchor base channel. The standoff can then be rotated at least a quarter turn. Once rotated, surfaces of the arms of the locking component abut surfaces of the channel. Nubs may abut flanges once the standoff is rotated. Also after rotation, the flange of the standoff and the top surfaces of the arms of the locking component abut the first pair of flanges of the side walls.

These and other objects and advantages of the invention will become apparent from the following detailed description of the invention. Both the foregoing general description and the following detailed description are exemplary and explanatory only and are intended to provide further explanation of the invention as claimed.

The accompanying drawings are included to provide a further understanding of the invention and are incorporated in and constitute part of this specification, as well as illustrate several embodiments of the invention that together with the description serve to explain the principles of the invention.

### BRIEF DESCRIPTION OF DRAWINGS

The features and components of the following figures are illustrated to emphasize the general principles of the present disclosure. Corresponding features and components throughout the figures can be designated by matching reference characters for the sake of consistency and clarity.

FIG. 1 displays a front, planar view of aspects of the present disclosure including an anchor base and a standoff.

FIG. 2 displays a front, planar view of aspects of the present disclosure including an anchor base interacting with a standoff.

FIG. 3 displays a front, planar view of aspects of the present disclosure including an anchor base interacting with a rotated standoff.

FIG. 4 displays a non-planar top view of aspects of the present disclosure including an anchor base and a standoff.

FIG. 5 displays a front, planar view of aspects of the present disclosure including an anchor base interacting with a rotated standoff.

FIG. 6 displays a front, planar view of aspects of the present disclosure including an anchor base interacting with a standoff.

FIG. 7 displays a front view of aspects of the present disclosure including an anchor base and a locking component.

FIG. 8 displays a view of a securing cover with an anchor base and a locking component according to an aspect of the present invention.

### DETAILED DESCRIPTION OF THE INVENTION

Embodiments of the invention will be described more fully hereinafter with reference to the accompanying drawings, in which embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

[In the following description, numerous specific details are set forth. However, it is to be understood that embodiments of the invention may be practiced without these specific details. In other instances, well-known methods, structures, and techniques have been shown in detail in order not to obscure an understanding of this description.

Unless defined otherwise, all technical and scientific terms used herein have the same meaning as commonly understood by one of ordinary skill in the art to which this disclosure belongs. Any systems and components similar or equivalent to those described herein can be used in the practice or testing of the present invention. All publications mentioned are incorporated herein by reference in their entirety.

The use of the terms “a,” “an,” “the,” and similar referents in the context of describing the presently claimed invention (especially in the context of the claims) are to be construed to cover both the singular and the plural, unless otherwise indicated herein or clearly contradicted by context.

Recitation of ranges of values herein are merely intended to serve as a shorthand method of referring individually to each separate value falling within the range, unless otherwise indicated herein, and each separate value is incorporated into the specification as if it were individually recited herein.

Use of the term “about” is intended to describe values either above or below the stated value in a range of approx. +/−10%; in other embodiments the values may range in value either above or below the stated value in a range of approx. +/−5%; in other embodiments the values may range in value either above or below the stated value in a range of approx. +/−2%; in other embodiments the values may range in value either above or below the stated value in a range of approx. +/−1%. The preceding ranges are intended to be made clear by context, and no further limitation is implied. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

The present disclosure can be understood more readily by reference to the following detailed description, examples, drawings, and claims, and their previous and following description. However, before the present systems and components are disclosed and described, it is to be understood that this disclosure is not limited to the specific systems and components disclosed unless otherwise specified, as such can, of course, vary. It is also to be understood that the terminology used herein is for the purpose of describing particular aspects only and is not intended to be limiting.

### I. Rotational Lock Mounting Systems

In an aspect, the present disclosure relates to a rotational lock mounting system 10. The rotational lock mounting system 10 can be used in combination with solar photovoltaic (PV) mounting systems. Rotational lock mounting systems 10 can be used to mount PV modules (e.g., panels) and arrays to a variety of surfaces including roofs. Roofs include but are not limited to tile roofs, shingle roofs, rolled asphalt roofs, wooden roofs, roofs comprising structural decking, roofs comprising rafters, and any other roof known in the art. Such a system 10 incorporates rotational lock fastening into PV mounting systems in a novel mannert. This provides faster and simpler installation of PV components, as described herein. Such rotational lock mounting systems 10 increase space between a surface and PV components mounted to such systems 10. PV components include a variety of PV components such as PV modules, PV arrays, PV apparatus, PV subsystems, and any other similar components known in the art.

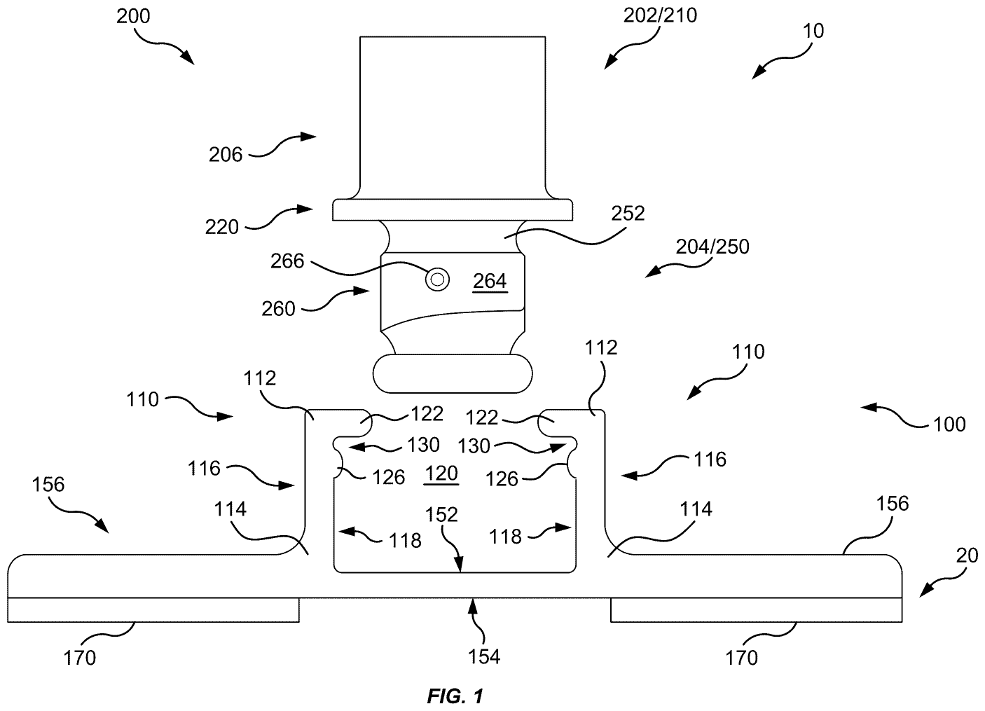

In an aspect, a system 10 includes anchor bases 100, standoffs 200, and in some instances a cover 300, as shown in FIGS. 1-8. Anchor bases 100 are configured to rest on a surface while standoffs 200 couple to PV components. The combination of the anchor bases 100 and standoffs 200 may be used on many different surfaces, including many different roof types and angles. Anchor bases 100 and standoffs 200 are configured to interact with one another to provide a unique interlocking function that allows a simple, fast, and secure assembly thereof. The anchor bases 100 and standoffs 200 are capable of being produced in various sizes. If the size of one component (i.e. an anchor base 100 or a standoff 200) is altered, the other component will likely also have to be adjusted such that the two components 100 and 200 remain compatible. Sizes may be altered based on the dimensions, including, but not limited to height, width, weight, and the like, of tile types (e.g., W or T tiles) and PV components to be used in conjunction with one or more anchor bases 100 and standoffs 200 of a rotational lock mounting system 10. Additional discussions of rotational lock mounting system 10 dimensions are discussed further herein.
A. Anchor Bases and Components Thereof

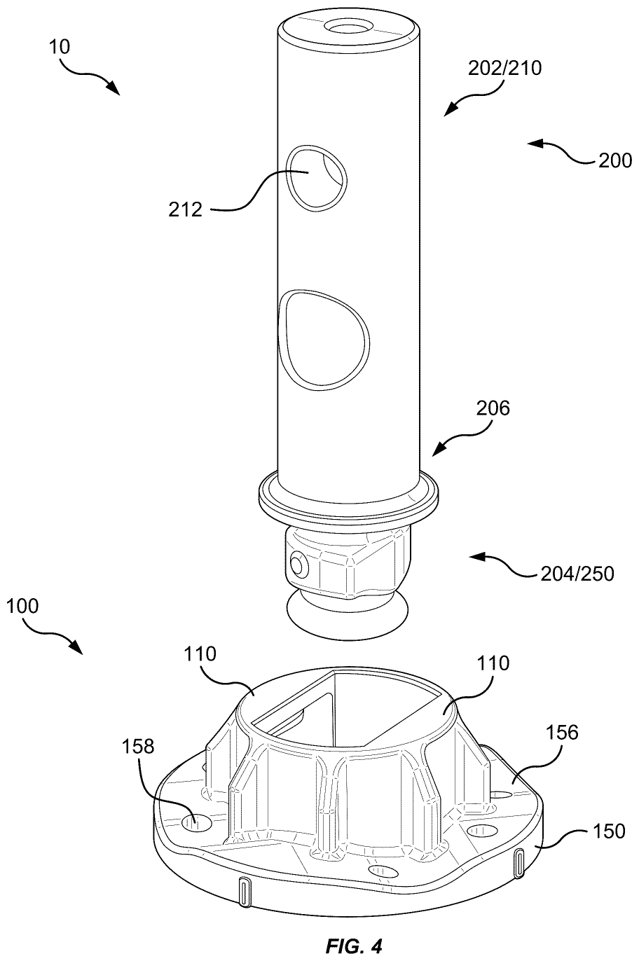

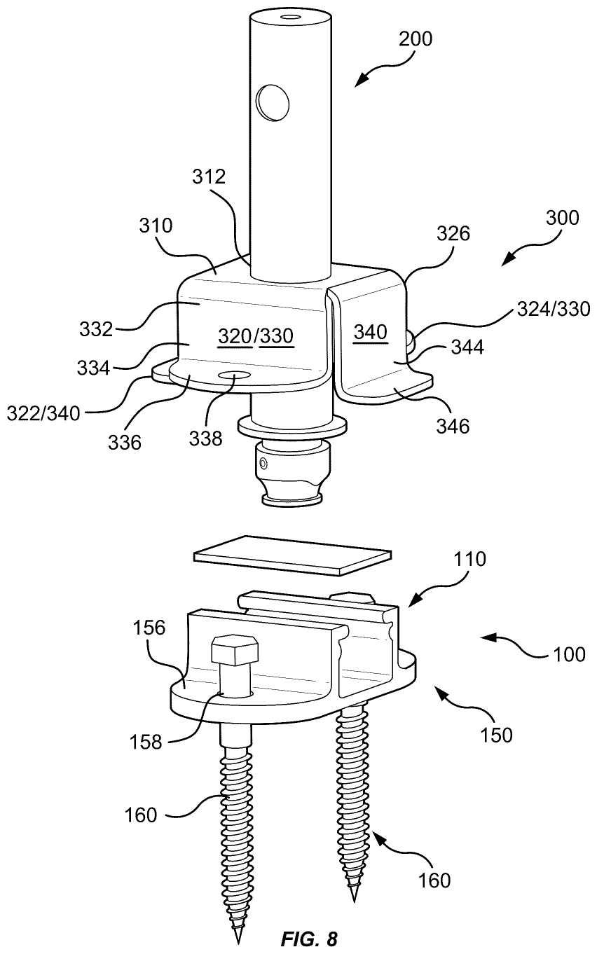

In an aspect, rotational lock mounting systems 10 include at least one anchor base 100. Anchor bases 100 may include a variety of shapes including, but not limited to, substantially quadrilateral (see FIGS. 1-3), circular (FIGS. 4-6), oblong (FIG. 8), and other shapes. In some aspects, the base 100 can be the same shape as the tiles on the roof on which is attached. In any case, the anchor base 100 can include side walls 110, as shown in FIGS. 1-6. In an exemplary aspect, an anchor base 100 may include two, three, four, or more side walls 110. In an additional, exemplary aspect, an anchor base 100 may include two side walls 110. Such side walls 110 include upper/top portions 112 extending upward from lower/bottom portions 114, as shown in FIGS. _. Side walls further include a first/outer surface 116 and a second/inner surface 118. Side walls 110 extend perpendicularly from a horizontal mounting portion 150, as discussed further below.

In an aspect, side walls 110 form a channel 120, as shown in FIGS. 1-2 and 7. The channel 120 is configured to receive the standoff 200, discussed below. The heights of the side walls 110 can vary, and may include heights of about 0.1 inches up to about 0.25 inches, about 0.125 inches up to about 0.225 inches, or about 0.15 inches up to about 0.20 inches. Higher side walls 110 may form deeper channels 120 configured to receive larger components associated with standoffs 200, as discussed further herein. Anchor bases 100 may also include widths. Such widths may be determined by the spacing of side walls 110, as shown in FIG. 1. Example widths include but are not limited to about 0.5 inches, about 1 inch, about 1.5 inches, about 2 inches, about 2.5 inches, about 3 inches, about 3.5 inches, about 4 inches, about 4.5 inches, about 5 inches, about 5.5 inches, about 6 inches, about 6.5 inches, about 7 inches, about 7.5 inches, about 8 inches, about 8.5 inches, about 9 inches, about 9.5 inches, or about 10 inches. Anchor bases 100 may also include lengths. Example lengths include but are not limited to about 0.5 inches, about 1 inch, about 1.5 inches, about 2 inches, about 2.5 inches, about 3 inches, about 3.5 inches, about 4 inches, about 4.5 inches, about 5 inches, about 5.5 inches, about 6 inches, about 6.5 inches, about 7 inches, about 7.5 inches, about 8 inches, about 8.5 inches, about 9 inches, about 9.5 inches, or about 10 inches. In some examples, an anchor base 100 may be circular in shape (See FIGS. 4-6). In such examples, a diameter of an anchor base 100 may be used to describe the anchor base 100. In such examples, a diameter of an anchor base 100 may include but is not limited to a diameter of about 0.5 inches, about 1 inch, about 1.5 inches, about 2 inches, about 2.5 inches, about 3 inches, about 3.5 inches, about 4 inches, about 4.5 inches, about 5 inches, about 5.5 inches, or about 6 inches.

The upper portions 112 of side walls 110 may additionally include a pair of flanges 122, as shown in FIGS. 1-6. Such flanges 122 extend away from the second surface 118 of the side wall 110 and towards the middle of the channel 120. In such an example, the flanges 122 on two side walls 110 may extend towards each other, as shown in FIG. 1. The flanges 122 may include lengths. Lengths may range from about 0.10 inches up to about 0.50 inches, or about 0.20 inches up to about 0.40 inches. In a particular example, upper flanges may be about 0.20 inches in length.

As a non-limiting example, as shown in FIGS. 1-3, side walls 110 may include at least two pairs of flanges 122, 126. In such an example, a side wall 110 may include upper flanges 122 with a second pair of flanges 126 underneath. The secondary flanges 126 extend in the same direction as the upper flange 122 (i.e. towards the channel 120 interior). As a non-limiting example, the secondary flanges 126 may be substantially shorter than the upper flanges 122. In such an example, the secondary flanges 126 do not extend as far into the interior of the channel 120 as do the upper flanges 122. In such an aspect, the upper flanges 122 and the secondary flanges 126 form a small channel or groove 130 between themselves along the upper portions 112 of the side walls 110, as shown in FIGS. 1-3.

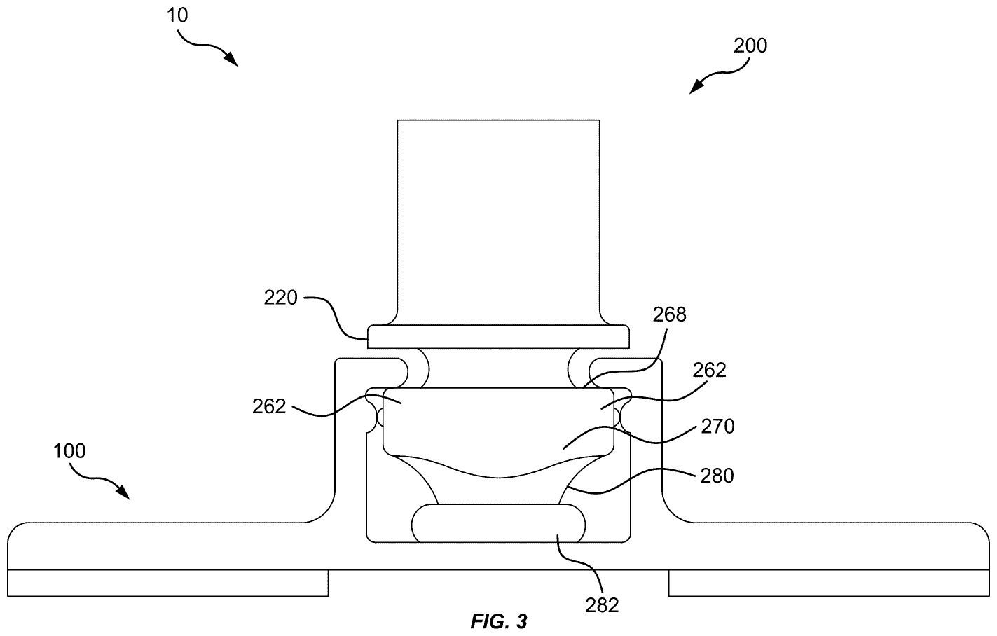

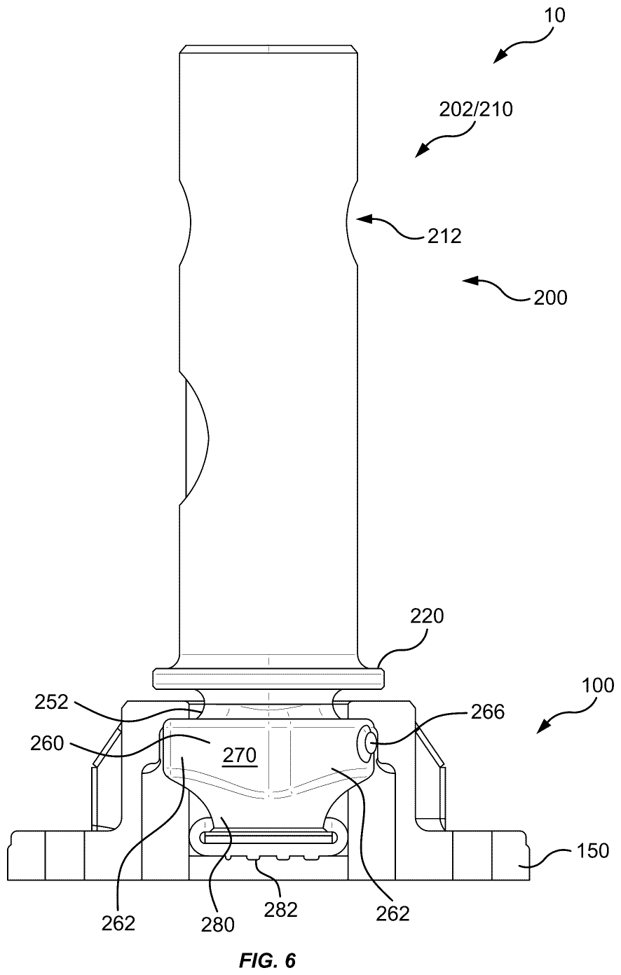

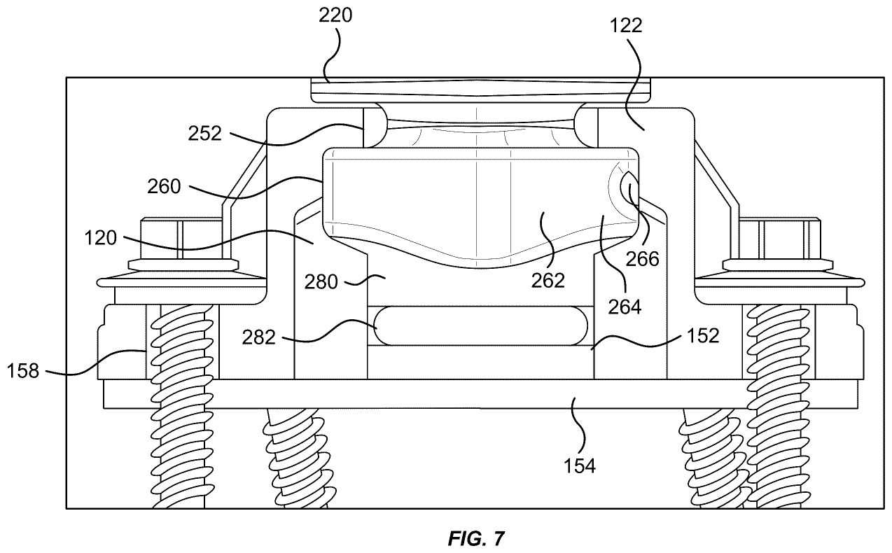

In an aspect, anchor bases 100 further include horizontal mounting portions 150, as shown in FIGS. 1-6 and discussed herein. Such horizontal mounting portions 150 are configured to abut a surface 20 upon which the system 10 rests. Horizontal mounting portions 150 include an upper/top surface 152 and an opposing, bottom surface 154, as shown in FIG. 3. In an aspect, the horizontal mounting portions 150 further include outer arms 156 extending in a horizontal direction from the outside surface 116 at the bottom of the side walls. As a non-limiting example, a horizontal mounting portion 150 can be configured to include a substantially flat upper surface 152, as shown in FIG. 1. As an additional, non-limiting example, a horizontal mounting portion 150 can be configured to include a raised portion on its upper surface 152 (i.e. non-flat/textured), as shown in FIG. 4. Horizontal mounting portions 150 additionally include a plurality of apertures 156, as shown in FIGS. 6-8. Such apertures 158 receive fastening devices 160 and allow a rotational lock mounting system 10 to be coupled to a surface. In a non-limiting example, an aperture 158 of a horizontal mounting portion 150 may receive a screw/fastener 160 that couples the system 10 to a surface 20, as shown in FIG. 7. In additional examples, butyl padding 170 may be placed below a locking system 10 before it is coupled to a surface, preventing water leaking through the surface 20 following coupling.

### Standoffs and Components Thereof

In an aspect, the present disclosure relates to a standoff 200. The standoff 200 includes an upper end 202, a lower end 204, and a middle section 206. A mounting portion 210 can be found at the upper end 202. The mounting portion 210 can be configured to couple to a PV module (e.g., panel) or array (not shown). A mounting portion 210 may include an aperture 212 extending through the mounting portion 210 configured to assist in coupling a PV module to the standoff 200, as shown in FIGS. 4-8. The mounting portion 210 can be configured to be substantially rod-like. In such an example, a mounting portion 210 may have a diameter of about 0.25 inches up to about 2 inches. In additional examples, a mounting portion 210 may have a diameter of about 0.5 inches up to about 1.75 inches, of about 0.75 inches up to about 1.5 inches, or about 1.0 inches up to about 1.25 inches. In an example, a mounting portion 210 may also include a height from about 2 inches up to about 8 inches. In additional examples, a mounting portion 210 may include heights from about 3 inches up to about 7 inches, or about 4 inches up to about 6 inches. The mounting portion 210 may additionally include other shapes including but not limited to prism shapes of various polygons. In an aspect, a standoff 200 also includes a flange 220. Such a flange 220 can be located along the middle section 206 of the standoff 200. In such an aspect, a flange 220 can be located at the border of a standoff mounting portion 210 and a locking component 250, as discussed further below.

In an aspect, a standoff 200 includes the locking component 250 found at a bottom end 204 of the standoff 200. The locking component 250 includes a first narrow portion 252 adjacent the flange 220 of the mounting portion 210, as shown in FIG. 1. In an aspect, the first narrow portion 252 has a width/diameter that is smaller than the distance between the flanges 122 of the base 100. Such a configuration allows the locking component 250 to rest within the channel 120 formed by side walls 110. As discussed above, larger locking components 250 may require varied dimensions of anchor bases 100. In an example, a wider locking component 250 may require walls 110 of an anchor base 100 to be spaced further apart. In an additional example, a taller locking component 250 may require walls 110 of an anchor base 100 to be include larger heights. In such examples, larger locking components 250 may be necessitated by larger or varied PV components to be mounted in conjunction with a rotational lock mounting system 10.

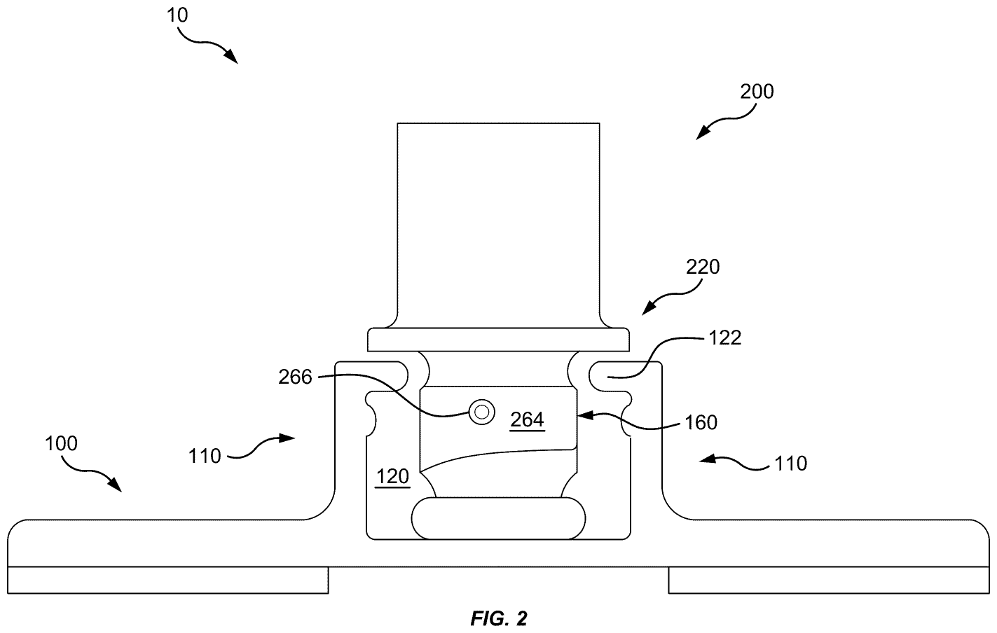

In such aspect, a middle portion 260 of the locking component 250 extends from the first narrow portion 252, as shown in FIGS. 1-6. The middle portion 260 may be wider than the first narrow portion 252. Extending from opposite sides of the middle portion 260 are at least two arms 262, best shown in FIGS. 3 and 6. The middle portion 260 includes an upper surface 268 and side surfaces 270 running along the arms 262. The side surfaces 270 may be substantially flat. In an additional aspect, the arms 262 may form a slightly curved shape, as shown in FIG. 2. In an aspect, the arms 262 may vary in width along their length.

Each of the at least two arms 262 further include nubs 266 on the ends 264 of the arms 262. In such an aspect, a nub 266 on the end 264 of an arm 262 may abut the secondary flanges 126 when a locking component 250 is rotated within an anchor base 100 as shown in FIG. 3, or the inner surfaces 118 of the side walls 110 of the base 100 under the flanges 122 as shown in FIG. 6. Such engagement assists in further securing the locking component 250 within the anchor base 100, as further discussed herein.

In an exemplary aspect, the length of the middle portion 260 running from a first end 264 of a first arm 262 to a second end 264 of a second arm 262 equals approximately the distance between the secondary flanges 126 as shown in FIG. 3. In another exemplary aspect, the length of the middle portion 260 running from a first end 264 of a first arm 262 to a second end 264 of a second arm 262 equals approximately the distance between the inner surfaces 118 of the side walls 110, as shown in FIG. 6. In another aspect, the distance from a first nub 266 on a first end 264 to a second nub 266 on a second end 264 of arms 262 is larger than the length from one arm end 264 to the other arm end 264, creating a friction hold of the locking component 250 within the channel 120 of the side walls 110.

In an aspect, a second narrow portion 280 further extends from the middle portion 260, as shown in FIG. 3. This second narrow portion 280 serves as a stabilizing portion 280 and is referred to interchangeably as such herein. The stabilizing portion 280 is used to engage the upper surface 152 of the mounting portion 150 of the anchor base 100. In an aspect, the stabilizing portion 280 may include an integrated deformable pad 282. A deformable pad 282 may be made of any material capable of deformation including a variety of polymers. Applicable polymers include but are not limited to ethylene propylene diene monomers (EPDMs). The deformable pad 282 can be pressed up against an upper surface 152 of the horizontal mounting portion 150. The combination of the stabilizing portion 280 and the deformable pad 282 assist in stabilizing the locking component 250 within the channel 120. As such, the deformable pad 282 firmly abuts the upper surface 152 to stabilize the locking component.

### Securing Cover

As shown in FIG. 8, the rotational lock mounting system 10 can include a securing cover 300 configured to work with the anchor base 100 and standoff 200, as shown in FIG. 8. In an aspect, the securing cover 300 includes a horizontal base 310. The horizontal base 310 includes an aperture 312 configured to receive the upper portion 210 of the standoff 200. The horizontal base 310 includes sides 320, 322, 324, 326. A pair of short clamps 330 extend downwardly from sides 320, 324 opposite one another. Similarly, a pair of long clamps 340 extend downwardly from sides 322, 326 opposite one another. In an aspect, the short clamps 330 are configured to engage with upper surface of the outer arms 152 of the horizontal mounting portion 150 of the anchor base 100, whereas the long clamps 340 are configured to come in contact with the surface 20 on which the base 100 is secured.

In an aspect, the short clamps 330 include a top end 332 and a bottom end 334, with the top end 332 being connected to the sides 320, 324 of the horizontal base 310. Flanges 336 can extend from the bottom end 334 in an outward horizontal direction. The flanges 336 of the short clamps 330 are configured to interact with/abut the outer arms 156 of the horizontal mounting portions 150. In an aspect, the flanges 336 include apertures 338. These apertures 338 can be configured to be aligned with the apertures 158 of the horizontal mounting portion 150. In such instances, the apertures 338 can be configured to receive the same fasteners 160 used to secure the anchor base 100 to the surface 20. In another instance, the apertures 338 can be sized to fit over the fasteners 160 of the anchor base 100 after being secured.

In an aspect, the long clamps 340 include a top end 342 and a bottom end 344, with the top end 342 connecting to the sides 322, 326 of the horizontal base 310. Flanges 346 can extend from the bottom end 344 of the long clamp 340 in an outward horizontal direction. The long clamps 340 can be configured to come into contact with side portions of the horizontal mounting portion 150 at the bottom ends 344, and the flanges 346 can come in contact or come close to the surface 20 on which the anchor base 100 is secured.

The securing cover 300 provides two functions—further securing the standoff 200 to the anchor base 100, as well as shielding portions of the anchor base 100 and the standoff 200 for unnecessary exposure of the elements.

### II. Methods of Use

In an aspect, the present disclosure relates to methods of use of embodiments described herein. In such an aspect, a standoff 200 is configured to interact and couple with an anchor base 100. Such interaction includes a portion of the standoff 200, such as a locking component 250, being inserted within a recess of an anchor base 100. The locking component 250 can then be manipulated to secure the overall standoff 200 within the anchor base 100, as further described below.

As a non-limiting example, a standoff 200 can be secured to an anchor base 100 by first inserting the locking component 250 into a channel 120 of the base 100, as shown in FIGS. 1-2. In such example, the locking component 250 is inserted until the stabilizing portion 280 firmly abuts the upper surface 152 of the horizontal mounting portion 150. In an aspect where a deformable pad 282 is coupled to the stabilizing portion 280, the deformable pad 282 will firmly abut the upper surface 152 upon insertion. After such insertion, the locking component 250 is oriented such that arms 262 of the middle portion 260 run parallel with the channel 120 of the base 100, as shown in FIG. 2.

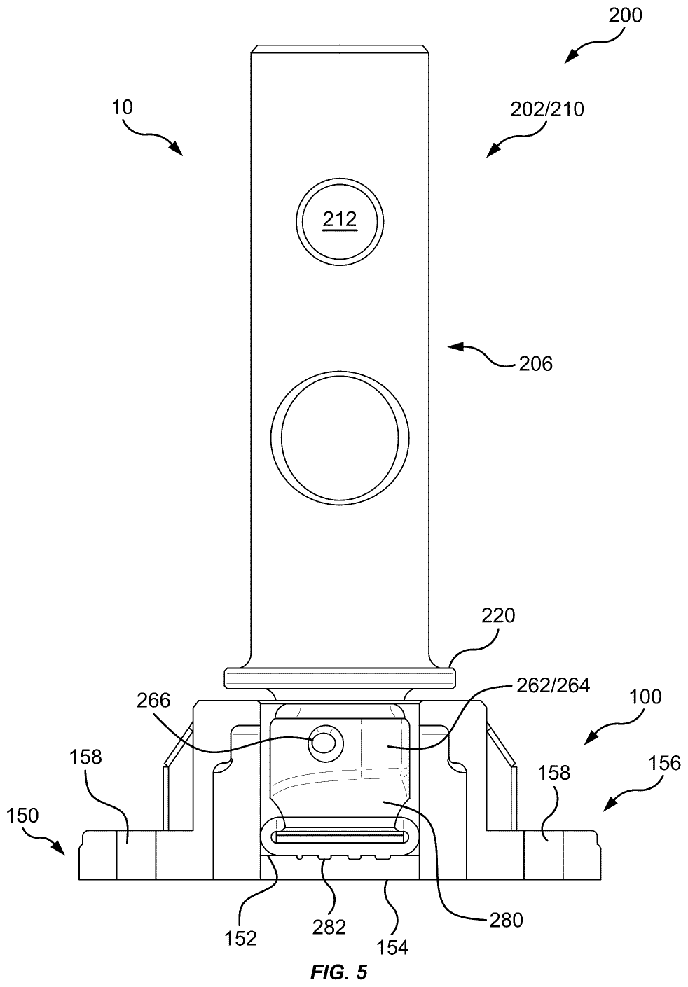

In such an example, a locking component 250 can be manipulated after insertion to secure the overall standoff 200 to the anchor base 100. As such, the standoff 200 is then rotated until the arms 262 of the middle portion 260 abut an inner surface of the channel 120. The standoff 200 can be rotated at least a quarter turn, at least a half turn, or at least a full turn (i.e. at least 90-degrees, at least 180-degrees, or at least 360-degrees). In a particular aspect, the standoff 200 can be rotated at least a quarter turn (i.e. at least 90-degrees). The inner surface that the arms 262 abut after rotation include the secondary flanges 126, as shown in FIGS. 3 and 5. After rotation, the flange 220 of the middle section 206 of the standoff 200 and the upper surface 268 of the arms 262 of the middle portion 260 are located substantially adjacent to the upper flanges 122 of the base 100, as shown in FIGS. 3 and 4. In an exemplary aspect, the flange 220 and the upper surface 268 of the arms 262 may firmly engage the upper flanges 122. Such engagement adds stability to the standoff received within the anchor base. In such an example, ends 264 of the arms 262 additionally abut secondary flanges 126 after rotation, as shown in FIG. 3.

In such an example, nubs 266 on the ends 264 of arms 262 are positioned within the channel 120 upon rotation. After rotation, nubs 266 may abut one or more of the lower flanges 126, as shown in FIG. 7. This interaction between nubs 266 and the lower flanges 126 may increase stability of the locking component 250 in its rotated configuration within the channel 120. Once received, an audible clicking may occur in situations where a deformable pad 282 is not used in conjunction with a locking component 250 (not shown) where the clicking is caused by nubs 266 abutting lower flanges 126. This auditory signal alerts the installer of reaching the locked position. In additional aspects, nubs 266 may rest against the stair-step configuration of flanges 122, 126, as shown in FIG. 5. In such an aspect, nubs 266 may provide an auditory signal to inform an installer of reaching the locked position.

In an aspect, the deformable pad 282 additionally stabilizes the standoff 200 within the channel 120, locking the standoff 200 in place. After rotation, the deformable pad 282 provides stability by exerting upward physical force on the locking component 250 as to hold it within the channel 120 by pressing upper surfaces 268 of arms 262 more firmly against upper flanges 122, as shown in FIG. 3.

In an aspect, installers may not hear a clicking sound, as described above, when a deformable pad 282 is used in conjunction with a locking component 250, as shown in FIG. 4. In such an aspect, an installer will be partly informed that a locking component 250 has been sufficiently rotated as to lock the standoff 200 into the anchor base 100 by one or more sensations. Sensations include a feeling that the standoff 200 can be rotated no further or that rotation has become more difficult, as constrained by the morphology and interactions between portions of a locking component 250 and an anchor base 100. One such interaction may occur as a result of the deformable pad 282. A deformable pad 282 may be limited in the extent to which it can deform or may become more difficult to deform as a standoff 200 is rotated.

In an example, a polymeric deformable pad 282 may be limited by its molecular structure and characteristics as to how far it can rotate. In such aspects, a deformable pad 282 may offer increased resistance to rotational forces as an installer rotates a standoff 200 within an anchor base 100. This may create a sensation informing the installer that the standoff 200 has been sufficiently rotated to achieve a lock. This resistance provided by a deformable pad 282 results from the interaction and friction between the deformable pad 282 and the upper surface 152 of the horizontal mounting portion 150, as shown in FIG. 3. In such aspects, deformation of a deformable pad 282 and positioning ends 264 of arms 262, as well as nubs 266, adjacent secondary flanges 126 of anchor bases 100 assist in locking a standoff 200 into an anchor base 100.

An installer may also have a general understanding that the standoff may be rotated approximately 90-degrees to secure a lock, as shown in FIGS. 2-3 and 5-6. As such, an installer may know, after rotating a standoff 200 90-degrees that a lock has been formed.

In aspects in which a securable cover 300 is used, the standoff 200 can be inserted via the aperture 312 of the horizontal base 310 of the securable cover 300 prior to installation of the anchor base 100 and standoff 200. The flanges 336 of the short clamps 330 can be aligned along the outer arms 156 of the horizontal mounting portion 150, with the bottom portion 344 of the long clamps 340 aligned/adjacent the sides of the horizontal mounting portion 150. From here, fasteners 160 can be inserted via the apertures 158/338 to secure both the cover 300 and the anchor base 100 to the surface 20. Once fastened, the standoff 200 can be rotated in the manner discussed above.

Having thus described exemplary embodiments of the present invention, it should be noted by those skilled in the art that the disclosures are exemplary only and that various other alternatives, adaptations, and modifications may be made within the scope of the present invention. Accordingly, the present invention is not limited to the specific embodiments as illustrated herein, but is only limited by the following claims.

What is claimed is:

1. A rotational lock mounting system for mounting photovoltaic modules onto a surface, the rotational lock mounting system comprising:
a. an anchor base, wherein the anchor base comprises at least two side walls extending perpendicularly from a horizontal mounting portion and forming a channel to receive an additional component of the rotational lock mounting system; and
b. a standoff, wherein the standoff comprises a standoff mounting portion configured to couple to at least one component of a photovoltaic module and a locking component opposing the standoff mounting portion configured to couple to the anchor base.

2. The rotational lock mounting system of claim 1, wherein the two side walls further comprise at least one pair of flanges positioned at the portion of the side walls furthest away from the horizontal mounting portion, the pair of flanges extending from the side walls towards the channel formed within.

3. The rotational lock mounting system of claim 1, wherein the standoff mounting portion comprises a flange located at the border of the standoff mounting portion and the locking component, and wherein a surface of the locking component abuts a surface of the flange.

4. The rotational lock mounting system of claim 1, wherein the standoff mounting portion extending away from the flange is substantially rod-like in shape.

5. The rotational lock mounting system of claim 1, wherein the locking component further comprises a first narrow portion, a middle portion, and a second narrow portion, wherein the two narrow portions are at opposing ends of the locking component, and wherein the middle portion is wider than the two narrow portions.

6. The rotational lock mounting system of claim 5, wherein the middle portion comprises at least two arms extending from the middle portion in parallel directions.

7. The rotational lock mounting system of claim 6, wherein the at least two arms each comprise a nub on the end of each of the at least two arms, and wherein the nub on the end of each of the at least two arms extends away from the center of the locking component.

8. The rotational lock mounting system of claim 1, wherein the locking component further comprises a stabilizing portion located on the end of the locking component opposing the standoff mounting portion.

9. The rotational lock mounting system of claim 8, wherein the stabilizing portion further comprises a deformable pad to be placed adjacent to a flat surface of the horizontal mounting portion of the anchor base to provide the rotational lock mounting system additional stability and to be engaged in locking the standoff into the anchor base.

10. The rotational lock mounting system of claim 8, wherein the horizontal mounting portion further comprises a raised portion, and wherein the stabilizing portion further comprises a deformable pad to be placed adjacent to the raised portion of the horizontal mounting portion of the anchor base to provide the rotational lock mounting system additional stability.

11. The rotational lock mounting system of claim 1, further comprising a securing cover configured to fit over the standoff and connect to the anchor base.

12. A method of mounting a photovoltaic module to a rotational lock mounting system, the method comprising:
a. inserting a first component of the rotational lock mounting system into a second component of the same mounting system such that a bottom surface of the first component abuts an internal surface of the second component; and
b. rotating the first component within the second component until the first surface is secure within the second component.

13. The method of claim 12, wherein the first component is a standoff, wherein the standoff comprises:
a. a standoff mounting portion configured to couple to at least one component of a photovoltaic module;
b. a flange positioned at an end of the standoff mounting portion; and
c. a locking component opposing the standoff mounting portion, the locking component comprising:
i. a first narrow portion;
ii. a middle portion comprising at least two arms extending from the narrow portion in parallel directions, wherein the at least two arms each comprise a nub on the end of each of the at least two arms;
iii. a second narrow portion; and
iv. a stabilizing portion located on the end of the locking component opposing the standoff mounting portion.

14. The method of claim 13, wherein the second component is an anchor base, wherein the anchor base comprises:
a. a horizontal mounting portion; and
b. at least two side walls extending perpendicularly from the horizontal mounting portion and forming a channel, wherein the at least two side walls further comprise a pair of flanges within the channel.

15. The method of claim 14, wherein the standoff is first inserted into the anchor base such that the at least two arms of the middle portion extend in parallel to the length of the channel formed by the side walls.

16. The method of claim 15, wherein the standoff is then rotated by approximately 90-degrees to secure the locking component within the anchor base.

17. The method of claim 15, wherein the standoff is then rotated by approximately 45-degrees to secure the locking component within the anchor base.

18. The method of claim 16, wherein the nubs on the ends of each of the at least two arms firmly abut an inner surface of the side walls after the standoff is rotated 90-degrees to assist in securing the locking component within the anchor base.

19. The method of claim 18, wherein the at least two arms of the locking component abut the pairs of flanges positioned further within the channel after the standoff is rotated.

20. The method of claim 18, wherein the pair of flanges positioned at the end of the standoff mounting portion abuts a top surface of the two side walls.
